(19) United States
(12) Patent Application Publication
(10) Pub. No.: US 2002/0144723 A1
(43) Pub. Date: Oct. 10, 2002

(54) Flexi-crutch

(76) Inventors: Anthony John Zulla, Coventry, RI (US); Robert Nicholas Colardo, Cranston, RI (US)

Correspondence Address: Robert Nicholas Colardo, 67 Warman Avenue, Cranston, RI, 02920, US

(21) Appl. No.: 09/933,541

(22) Filed: Aug. 21, 2001

Related U.S. Application Data
(60) Provisional application No. 60/283,223, filed on Apr. 9, 2001.

(51) Int. Cl. A61H 3/02

(52) U.S. Cl. 135/71; 135/68; 135/69

(57) ABSTRACT

A pair of crutches of walker type, each being made with a moveable, spring-loaded shoulder support. The shoulder support incorporates an eye bolt that pivots at its center axis from the shoulder support, then down through a flat stock steel spring. It follows through a crossmember which secures both sides of the crutch. The spring action at the shoulder support acts as a cushion when the individual's body weight is shifted. This creates a forward, and rear movement with each stride. This pivoting, spring action provides the user comfort and less pressure and shock under the arm pit area.

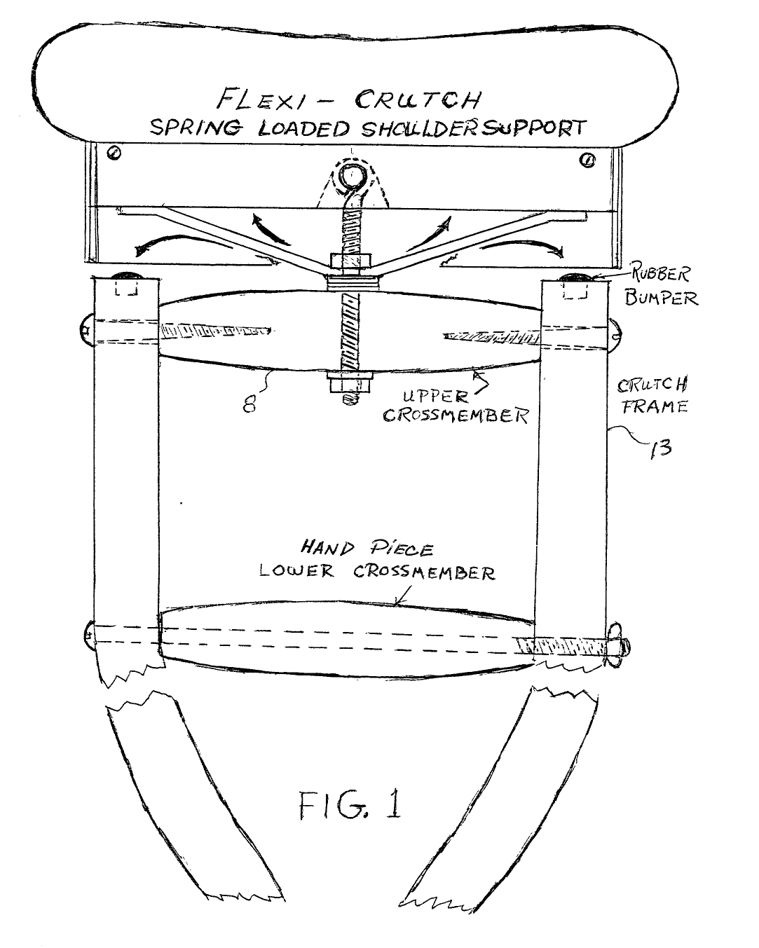

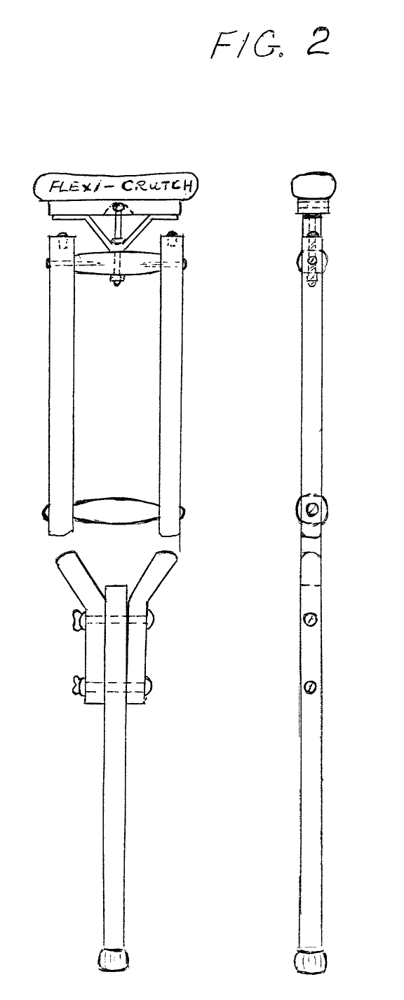

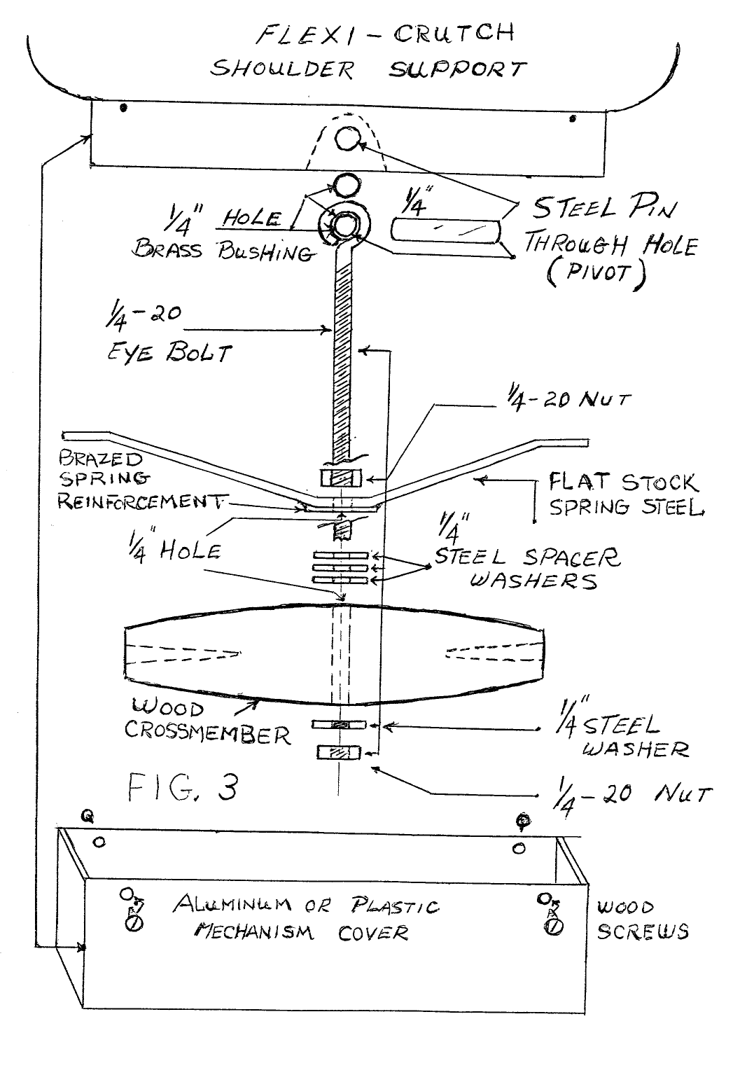

### SUMMARY

The purpose of this invention is to allow the user to proceed with the assistance of crutches in a more comfortable manner. The action of the mechanism permits the user to adjust the angle of the shoulder support to switch positions while the user is walking. If the crutch is extended forward, the forward portion of the shoulder support responds to that angle and pivots accordingly. Likewise, when the angle is reversed, the rear portion of the shoulder support reverses and pivots in the opposite angle.

The crutch can be made of either wood or metal. round tubing, square or rectangular aluminum, which is very lite and strong, may be used for constructing the crutch.

### SPECIFICATIONS

This invention relates generally to crutches particularly of walker type such as are used by permanently or temporarily disabled individuals. More specifically several variations of design and modification are possible, with the use of various materials used to construct the crutch.

The Flexi-Crutch is an adaptation of an added feature or device which aids the user to become more comfortable while utilizing crutches as a walking aid. The device consists mainly of a thin, flat metal spring 6 that has a center axis in which to pivot. The shoulder piece 1 has a cut-out exactly in the center allowing a threaded ¼″-20 eye bolt 5 that has a brass bushing 3 and a steel pin 2 that secures the eye bolt 4 in position. This eye bolt 4 extends from the center of the shoulder support 1 projecting down to the lower crossmember 8 which contains ¼″ flat washers 7 that can be added or subtracted to adjust spring tension. The bottom crossmember 8 is drilled through to accept the eye bolt 4 and is fastened by a flat washer 9 and a ¼″-20 nut 10.

Unlike other devices that I have researched at the Providence Public Library, the only other mechanism, U.S. Pat. No. 5,628,335, that I discovered was a dual-spring crutch with the shoulder support resting on each coil springs which acted as a shock absorber. This mechanism did not have a rocking motion, but instead had an up-and-down motion. Other adaptations could be utilized to obtain the same action. E.g. a flat spring could be positioned along the sides of the upper crutch frame to act in the same manner as the mechanism illustrated. The distance of travel between its axis can also be obtained by the spacing between the shoulder support 1 and the upper portion of the crutch frame. This condition occurs when the shoulder support 1 tilts or rocks in either direction, it subsequently stops at the tops of either side of the crutch frame.

### VIEWS OF THE DRAWING

Page #1 of the drawings illustrates the mechanism together as a unit with a cut-away view of the upper portion of the crutch. It illustrates the upper shoulder support attached to the ¼″-20 threaded pivot bolt that is attached by an eye bolt, bushing and steel pin.

Page #3 illustrates an exploded view of the individual parts that are connected in sequence. The main spring measures approximately ⅞″×0.030 of an inch. spring tension can be altered by using either thinner or thicker spring steel. As noted in the exploded view, an extra thickness of steel is either brazed or silver soldered to the bottom of the spring for extra reinforcement. This piece must be added to the spring because a ¼″ hole is drilled through the spring to allow the eye bolt to enter and fasten it to the lower crossmember. This piece also prevents the spring from breaking, allowing more stability.

The two views that I submitted should be sufficient enough to illustrate the mechanism. If certain portions are unclear, I will further submit additional drawings or views for clarification.

The exploded view clearly illustrates the mechanism that is simple and yet greatly enhances the comfort when the crutches are in use.

Although traditionally made of wood, crutches can be made of aluminum tubing, solid aluminum bar stock and wood. Any of these materials can be used well with the illustrated mechanism. Any manufactured crutch can be easily modified to incorporate this mechanism.

The views shown can be modified, whereas the pivot spring could be positioned and fastened to the shoulder support. This allows spring action to the lower crossmember. The spring or springs can be fastened to each side of this crutch, extending to the bottom of the shoulder support.

What is claimed:

1. An arm crutch comprising of an eye bolt, spring and nut washers, to maintaining flexibility and stability along with comfort.

2. Mainly the mechanism is easily accessible to repair by removing a nut that is connected beneath the upper crossmember.

3. In the event the spring should break, the stability is still maintained. This will protect the user.
